(19) United States
(12) Patent Application Publication
(10) Pub. No.: US 2019/0373380 A1
(43) Pub. Date: Dec. 5, 2019

(54) ADAPTATION OF HEARING DEVICE PARAMETERS USING ULTRASOUND SIGNAL TRANSMITTERS, HEARING DEVICE AND SYSTEM

(71) Applicant: SIVANTOS PTE. LTD., SINGAPORE (SG)

(72) Inventor: MICHAEL BLENDINGER, NUERNBERG (DE)

(21) Appl. No.: 16/418,040

(22) Filed: May 21, 2019

(30) Foreign Application Priority Data
May 29, 2018 (DE) 102018208502.1

(51) Int. Cl. H04R 25/00

(52) U.S. Cl. CPC H04R 25/505; H04R 2225/41; H04R 25/554

(57) ABSTRACT

A method adapts parameters in a hearing device. To implement the method, a sensor for receiving ultrasound signals and a signal processing device are used to process the ultrasound signals. As a result of processing the ultrasound signals, parameters are changed in order to adapt the hearing device. The source of the ultrasound signals is a signal transmitter that is devised to output sound signals of different frequencies. The signal transmitter is positioned independently of the hearing device and the user of the hearing device, and transmits the ultrasound signals independently of the user of the hearing device.

### CROSS-REFERENCE TO RELATED APPLICATION

This application claims the priority, under 35 U.S.C. § 119, of German application DE 10 2018 208 502.1, filed May 29, 2018; the prior application is herewith incorporated by reference in its entirety.

### BACKGROUND OF THE INVENTION

### Field of the Invention

The present invention relates to a method for adapting parameters in a hearing device and to a hearing device for use with that method. The invention also relates to a system with a hearing device and an external device having a data link with the hearing device for use with the method.

Hearing devices are wearable hearing apparatuses that are used, among other applications, to assist the hearing-impaired. To meet numerous individual requirements, different types of hearing devices are manufactured, such as behind-the-ear (BTE) hearing devices, hearing devices with external receiver (RIC: receiver in canal) and in-the-ear (ITE) hearing devices, for example Concha hearing aids or completely-in-canal (CIC) hearing devices. These hearing devices, which are listed by way of example, are worn on the outer ear or inside the ear canal.

Hearing devices generally have as their main components an input transducer, an amplifier and an output transducer. The input transducer is usually a sound receiver, such as a microphone, and/or an electromagnetic receiver, such as an induction coil. The output transducer is usually realized as an electroacoustic transducer, such as a miniature speaker, or as an electromechanical transducer, such as a bone conduction receiver. In hearing devices, an electroacoustic output transducer is often referred to as a receiver. The amplifier is typically integrated into a signal processing unit. A signal processing unit of this kind is also referred to as a circuit, circuit device or hybrid circuit.

### SUMMARY OF THE INVENTION

The properties of a hearing device in use are influenced by various settings that may be adjusted on the hearing device. The user may be able to change and adapt some of these settings, such as parameter settings like volume or a specific program. The hearing device may also set certain settings automatically.

European patent EP 1 753 264 B1, corresponding to U.S. Pat. No. 7,916,881, discloses a hearing device and a method for adjusting the settings thereof. The hearing device contains a first sound output device for providing acoustic supply to the user's ear, and a second sound output device that is distinct from the first sound output device. The hearing device also contains an acquisition device. By means of the second sound output device, a test sound is generated in the ultrasound range and is emitted into a room where the hearing device is located. The acquisition device acquires a response to the test sound from the room. Dependent on the response acquired, the analysis device ascertains information about room acoustics, and this information is used to adjust the settings of a signal processing device of the hearing device.

Hearing devices have now become technically capable of analyzing the environment themselves and then changing certain parameters. Such a process, in the case of hearing devices, is referred to as classification or environmental classification. The setting parameters that are adjusted or changed may be, for example, a directional setting of the microphones (beamforming) so as to focus on a certain speaker to whom the user wants to listen, or suppressing certain noises such as engine noise when driving.

In addition, parameters in hearing devices may also be set based on information from external signals. A classic example is parameter adjustment using a remote control or mobile telephone that has a communicative connection to the hearing device and functions as a remote control by means of add-on functionality.

However, these automatic setting options are not always reliable. Some parameters may be set incorrectly because the environment was analyzed incorrectly, or could not be analyzed correctly. This may have uncomfortable effects for the hearing device user. For example, the focusing of the microphones may fail, so that the user hears in a different direction from the direction actually desired.

The following is proposed to overcome these drawbacks.

A method for adapting parameters in a hearing device in which a sensor for receiving ultrasound signals and signal processing device are arranged in order to process the ultrasound signals. As a result of the processing of the ultrasound signals, one or more parameters for adapting the hearing device are changed. The source of the ultrasound signals is a signal transmitter which is set up to emit sound signals of different frequencies. Such a signal transmitter may also be referred to as a beacon or ultrasonic beacon. The signal transmitter is generally suitable for emitting ultrasound signals and non-ultrasound signals, such as for example human-audible audio signals. The signal transmitter is positioned in a locally stationary manner, independently of the hearing device and hearing device user, and emits sound signals independently of the hearing device user.

A simple example of such a signal transmitter is a loudspeaker that is set up in a specified place. This loudspeaker is able to output at least ultrasound signals. A hearing device user, who is in acoustic proximity to the signal transmitter or passes it, receives the ultrasound signals, for example by means of the hearing device. The hearing device user has no direct influence on the ultrasound signals that the signal transmitter emits.

The ultrasonic range of the acoustic frequency spectrum is generally above the human-audible sound range. Sound frequencies from approximately 16 kHz up to 1 GHz may be described as ultrasound. In addition, these ranges vary, and may seem different from one person to another.

The signal transmitter is often referred to as a “beacon” or “ultrasonic beacon.” Such beacons may be, for example, TV sets, movie projectors or loudspeakers that are able to emit ultrasound signals. As a general matter, anything that is suited to emit ultrasound signals may be a signal transmitter in this sense.

In another embodiment, the sensor is arranged inside the hearing device. For example as a microphone.

In another embodiment, an external device is communicatively connected to the hearing device via a data link. In this case, the sensor is arranged inside the external device. The sensor may for example be a microphone.

In another embodiment, the signal processing device is arranged inside the hearing device.

In another embodiment, an external device is communicatively connected to the hearing device via a data link and the signal processing device is arranged inside the external device.

In another embodiment, the ultrasound signals contain data for use in setting the parameters of the receiving hearing device. The parameters of a hearing device are for example: The general or specific volume settings for certain frequency ranges; acoustic amplification in general or for certain frequency ranges; settings for classification of the environment, for example by terms such as forest, car, cocktail party, loud environment, quiet environment or the like; settings for the directivity of the microphones, also known as beamforming; filter properties for certain frequencies; selection of certain preset programs; etc.

In another embodiment, the ultrasound signals the signal transmitter emits contain data for ascertaining the position of the signal transmitter and/or regarding the environment of the signal transmitter. In addition to information on the location or environment of the signal transmitter, this data may also contain other data regarding the location, for example coordinates of a global positioning system such as GPS coordinates, GLONASS coordinates or Galileo coordinates. Based on this data, the parameters of the hearing device may be set or adjusted. For example, the data may contain the information that the signal transmitter is located in a shopping mall. The hearing device parameters may then be set using this data. In this example, it might be assumed that in a shopping mall, many people will be crowded together. Such crowds of people may produce a great deal of noise. Thus, for example, the parameter that controls the sensitivity or omni-directionality of the hearing device microphone might be adjusted accordingly.

In another embodiment, the data is transmitted in the ultrasound signal in encoded form. Examples of this may include different modulations, such as amplitude, phase or frequency modulation. However, other ways and methods of coding are also possible. This data may then be decoded in a decoding device. For example, the decoding device may be a part of the signal processing device and may be arranged inside the hearing device. The decoding device may also be accommodated in an external device that is communicatively connected with the hearing device. In this case, decoding takes place inside the decoding device of the external device. For example, this external device may be a mobile telephone connected to the hearing device via a wireless connection.

In another embodiment, the signal transmitter transmits the ultrasound signal simultaneously with an audio signal in the human-audible frequency range. In other words, sound signals from the human-audible and human-inaudible frequency spectrum may be emitted simultaneously. Thus for example the signal transmitter may transmit music or acoustic advertisement simultaneously with the ultrasound signals mentioned above. The signal transmitter is this case may for example be a loudspeaker that is also suitable for generating ultrasound signals.

In another embodiment, the ultrasound signals are in a frequency range greater than or equal to 18 kHz. In another embodiment, the ultrasound signals are in a frequency range of 18 kHz-20 kHz. In another embodiment, the ultrasound signals are in a frequency range of 18.7 kHz-19.2 kHz. These ranges are particularly technically well-suited for small electronic devices, such as for example hearing devices or mobile telephones, to receive ultrasound signals.

Other features which are considered as characteristic for the invention are set forth in the appended claims.

Although the invention is illustrated and described herein as embodied in a adaptation of hearing device parameters using ultrasound signal transmitters, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic representation of a method according to the invention in which parameters of a hearing device wearer's hearing device are adjusted for the hearing device user based on a user's environment;

FIG. 2 is an illustration of an extended embodiment of the method from FIG. 1; and

FIG. 3 is an illustration of additional possible schematic representations of embodiments of the method according to the invention.

### DETAILED DESCRIPTION OF THE INVENTION

In the following, various embodiments are described. This expressly does not represent a limitation of the invention to the described embodiments. There are other possible embodiments within the scope of the invention.

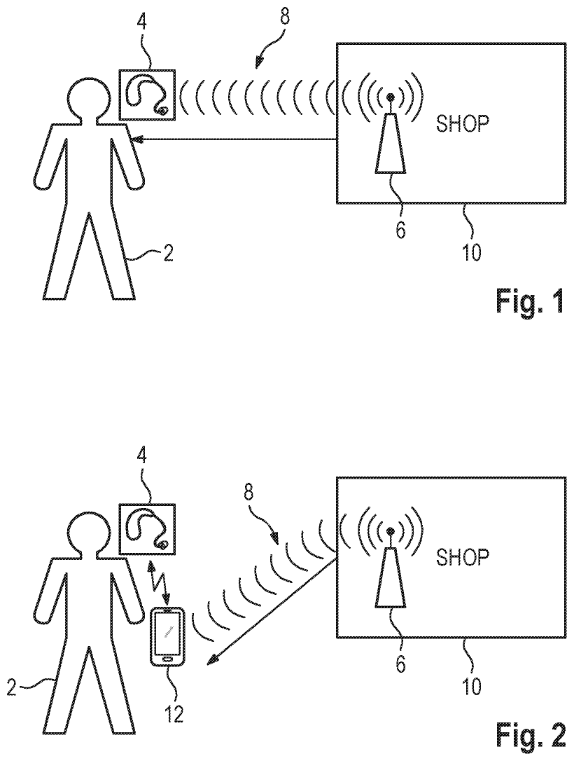

Referring now to the figures of the drawings in detail and first, particularly to FIG. 1 thereof, there is shown a hearing device wearer 2 with a hearing device 4 that the wearer wears on one ear. FIG. 1 also shows a shop 10, which may for example be located in the pedestrian district of a city or in a shopping mall. A signal transmitter 6 is placed inside or outside the shop 10. The signal transmitter 6 may, for example, be a loudspeaker that is suitable for emitting human-audible sound as well as sound in the ultrasound range that is human-inaudible or audible only with difficulty. This roughly comprises a frequency range from approximately 20 Hz to approximately 20,000 Hz. The signal transmitter 6 thus emits different sound signals of different frequency ranges or wavelengths, including an ultrasound signal 8. The hearing device 4 is arranged so as to receive and process the ultrasound signal 8.

In this specific case, the hearing device wearer 2 now passes a retail shop 10. The signal transmitter 6, which is configured as a loudspeaker, emits not only acoustically audible advertising messages but also an inaudible ultrasound signal 8. The ultrasound signal 8 contains, for example, information or data regarding the location of the signal transmitter 6. This data may be transmitted in the ultrasound signal 8 in encoded form. The hearing device 4 receives the ultrasound signal 8 depending on the position of the signal transmitter 6 and the hearing device 4 or hearing device wearer 2 relative to one another. In other words, the hearing device 4 must be within the acoustic range of the ultrasound signal 8 to receive the signal.

The hearing device 4 is arranged so as to evaluate, and if necessary to convert, the transmitted information of the ultrasound signal 8 after receiving it. Thus, in this example, the signal processing in the hearing device 4 receives, among other things, data containing information on the location of the signal transmitter 6, which is located for example in a shopping mall. With this information, for example, the classification of the hearing device 4 may be adjusted. In the present example, the noise filtering could be adjusted or the volume could be increased, because it is assumed that a shopping mall will have a high density of people and therefore a high level of noise. Alternatively, for example, the focus range of the microphone alignment may also be adjusted.

Other examples of data or information transmitted via the ultrasound signal 8 are: Exact geo-localization data, such as GPS coordinates, which may for example be compared with the hearing device's own contemporaneous location classification. Cameras in the vicinity may detect or calculate a human density as a value that the signal transmitter 6 transmits; as a result, hearing devices 4 adjust their parameters accordingly, such as for example parameters for noise filtering.

Another embodiment according to FIG. 1 is the transmission of advertising-specific information or data from the shop 10 by means of the signal transmitter 6. The underlying idea is to financially subsidize hearing devices. In return for this subsidy, these hearing devices are, for example, programmed or set up so as to amplify certain acoustic advertising messages, or to focus acoustically on a shop 10 when corresponding data is received from an associated signal transmitter 6. Data are sent to the hearing device 4 by the method described above, causing hearing device parameters to be set in such a way that the advertising messages that the signal transmitter 6 additionally transmits are amplified in the acoustic range that is audible to the hearing device wearer 2, or moved into the acoustic foreground, in such a way that the wearer perceives these messages rather than other aspects of the acoustic environment. This embodiment of an advertising-aware hearing device is one way of providing cheaper hearing devices through corresponding subsidies.

FIG. 2 shows an alternative form of the embodiments according to FIG. 1. In this case, the hearing device wearer 2 carries another mobile device 12 next to the hearing device 4. The mobile device 12 is an external device 12 according to the claimed invention. It may be, for example, a mobile telephone in the form of a smartphone. The mobile device 12 is communicatively connected to the hearing device 4. “Communicatively connected” means, for example, that the hearing device 4 and the mobile device 12 are able to exchange data bidirectionally. Alternatively, one of the devices may send data unidirectionally to the other, for example from the mobile device 12 to the hearing device 4. This type of data exchange takes place, for example, between the hearing device 4 and the mobile device 12 by means of a radio link, also known as an RF link.

In this embodiment, the mobile device 12 receives the ultrasound signal 8 and immediately processes it. Alternatively, the data of the ultrasound signal 8 may be transmitted via the communicative connection to the hearing device 4 and may be processed there.

As in the foregoing exemplary embodiments, the hearing device wearer 2 with the hearing device 4 and the mobile device 12 comes near the signal transmitter 6. The mobile device 12 in this case receives the ultrasound signal 8 that the signal transmitter 6 transmits. For example, a special sensor or microphone may be built into the mobile device 12 to receive ultrasound. For example, if the mobile device 12 is a conventional smartphone, the microphones used may be the kind of microphones that are typically used in a telephone of that design.

In a first variant of this embodiment, data from the received ultrasound signal 8 is converted inside the mobile device 12 in such a way that the data may be sent via the communicative connection directly to the hearing device 4, where it may be used to set or change parameters thereof.

In another variant of this embodiment, the data transmitted in the ultrasound signal 8 is processed in a corresponding signal processing or data processing device of the mobile device 12. Settings or parameters for the hearing device 4 are obtained as a result of this signal processing. These settings or parameters are sent to the hearing device 4 via the communicative connection and may then adjust or change the existing settings and parameters of the hearing device 4 accordingly.

Although not shown, the external device 12 may also be a device other than a mobile telephone. For example, intermediate devices in the form of neckbands are used to facilitate wireless communication between hearing devices and other devices. In neckbands of this kind, an electronic apparatus is built in that serves to wirelessly bridge between hearing devices and other wireless devices that cannot communicate directly with each other wirelessly due to their technical characteristics.

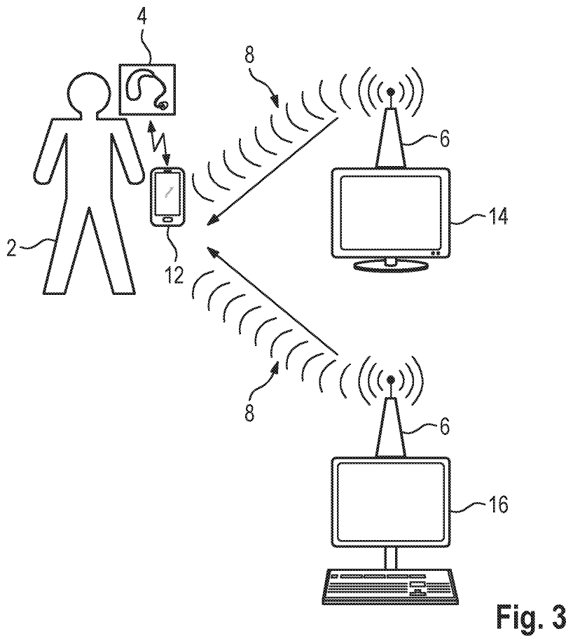

FIG. 3 shows other embodiments of the method according to the invention. One such embodiment relates to the use of a TV set 14 on which an ultrasound signal transmitter 4 is arranged, or which performs the function of an ultrasound signal transmitter 6 by means of a built-in loudspeaker. The hearing device user 2 is watching television while using the hearing device 4. The content of the TV program changes without the hearing device user 2 having to intervene. For example, in a movie, there may be loud scenes with many people talking followed quickly by quiet scenes with few people talking. Based on these content changes, the signal transmitter 6 of the TV set 14 may transmit ultrasound signals 8 that contain data that in turn adjusts the parameters of the hearing device 4 according to the scenes shown as they are received. Thus, the listening experience is continuously optimized for the respective moment.

As in the foregoing embodiments, the signal transmitter 6 of the TV set 14 may receive the ultrasound signals 8 either from the hearing device 4 or from an external device 12; in the latter case, the external device is communicatively connected to the hearing device 4 as described above.

In another embodiment shown in FIG. 3, the hearing device wearer 2 is using a computer 16. An ultrasound signal transmitter 4 is arranged on the computer 16 or the function of an ultrasound signal transmitter 6 is carried out by means of a built-in loudspeaker. For example, the computer 16 may be set so that its signal transmitter 6 emits an ultrasound signal 8 with data for changing the parameters of the hearing device 4, causing the hearing device 4 to reduce the sensitivity of the microphones for certain frequencies, such as predefined speech frequencies, when it receives the signal. In this way, the hearing device user 2 may work in a more concentrated manner with the computer 16 and may be less distracted by speech in the user's environment, because in this case, the microphones pick up the speech in the environment with less sensitivity. In other words, the speech in the environment is damped or simply made quieter. Alternatively, the parameter change in the hearing device may cause these respective frequencies to be temporarily filtered out in the signal processing, or may temporarily reduce the amplification of certain frequencies.

As in the foregoing embodiments, the signal transmitter 6 of the computer 16 may receive the ultrasound signals 8 either from the hearing device 4 or from an external device 12; in the latter case, the external device is communicatively connected to the hearing device 4 as described above.

The embodiments described above are only some examples of possible applications of the invention.

The following is a summary list of reference numerals and the corresponding structure used in the above description of the invention:
2 Hearing device wearer
4 Hearing device
6 Signal transmitter
8 Ultrasound signal
10 Shop
12 External device/mobile device
14 TV set
16 Computer device

1. A method for adapting parameters in a hearing device, which comprises the steps of:
providing a sensor so as to receive ultrasound signals, wherein a source of the ultrasound signals is a signal transmitter disposed to output sound signals of different frequencies;
providing a signal processing device so as to process the ultrasound signals;
changing the parameters for adapting the hearing device based on a processing of the ultrasound signals;
positioning the signal transmitter independently of the hearing device and a user of the hearing device; and
outputting, via the signal transmitter, the ultrasound signals independently of the user of the hearing device.

2. The method according to claim 1, wherein the sensor is disposed inside the hearing device.

3. The method according to claim 1, which further comprises providing an external device which has a data link with the hearing device, and in that the sensor is disposed inside the external device.

4. The method according to claim 1, wherein the signal processing device is disposed inside the hearing device.

5. The method according to claim 1, which further comprises providing an external device which has a data link with the hearing device, and in that the signal processing device is disposed inside the external device.

6. The method according to claim 1, wherein the ultrasound signals contain data for use in setting the parameters of the hearing device.

7. The method according to claim 1, wherein the ultrasound signals that the signal transmitter transmits contain data for ascertaining a position of the signal transmitter and/or regarding an environment of the signal transmitter.

8. The method according to claim 7, wherein the signal processing device sets or adapts the parameters of the hearing device based on the data for ascertaining the position and/or regarding the environment of the signal transmitter.

9. The method according to claim 6, which further comprises transmitting the data in the ultrasound signal in an encoded form.

10. The method according to claim 9, which further comprises decoding the data in a decoding device.

11. The method according to claim 10, which further comprises providing an external device with a decoding device that has a data link with the hearing device, and the decoding takes place in the decoding device of the external device.

12. The method according to claim 1, wherein the signal transmitter transmits the ultrasound signal simultaneously with an audio signal in a human-audible frequency range.

13. The method according to claim 1, wherein the ultrasound signals are in a frequency range greater than or equal to 18 kHz.

14. The method according to claim 1, wherein the ultrasound signals are in a frequency range of 18 kHz-20 kHz.

15. The method according to claim 1, wherein the ultrasound signals are in a frequency range of 18.7 kHz-19.2 kHz.

16. The method according to claim 1, which further comprises using a microphone as the sensor.

17. A hearing device, comprising:
a sensor for receiving ultrasound signals, wherein a source of the ultrasound signals is a signal transmitter disposed to output sound signals of different frequencies, the signal transmitter is positioned independently of the hearing device and a user of the hearing device, and the signal transmitter outputs the ultrasound signals independently of the user of the hearing device; and
a signal processing device connected to said sensor and processing the ultrasound signals, said signal processing device programmed to change parameters for adapting the hearing device based on a processing of the ultrasound signals.

18. A system, comprising:
a signal transmitter;
a hearing device, containing:
a sensor for receiving ultrasound signals, wherein a source of the ultrasound signals is said signal transmitter disposed to output sound signals of different frequencies, said signal transmitter is positioned independently of said hearing device and a user of said hearing device, and said signal transmitter outputting the ultrasound signals independently of the user of said hearing device; and
a signal processing device connected to said sensor and processing the ultrasound signals, said signal processing device programmed to change parameters for adapting the hearing device based on a processing of the ultrasound signals; and
an external device having a data link with said hearing device.
